(19) United States
(12) Patent Application Publication
(10) Pub. No.: US 2008/0261657 A1
(43) Pub. Date: Oct. 23, 2008

(54) Plug-In Device for Enabling Mobile Telephone to Execute Applications

(75) Inventor: Jonathan Amit, Omer (IL)

Correspondence Address: EDWARDS ANGELL PALMER & DODGE LLP, P.O. BOX 55874, BOSTON, MA, 02205, US

(73) Assignee: MobilMax, Inc., Gaithersburg, MD (US)

(21) Appl. No.: 11/793,790

(22) PCT Filed: Dec. 1, 2005
(86) PCT No.: PCT/IL05/01294

§ 371 Date: Mar. 3, 2008

Related U.S. Application Data
(60) Provisional application No. 60/638,150, filed on Dec. 21, 2004.

(51) Int. Cl. H04B 1/38

(52) U.S. Cl. 455/558

(57) ABSTRACT

A device for plugging into the data port of a mobile telephone, for enabling the mobile telephone to execute user applications; and a method for developing such devices and programming the applications therein. Application plugs may be inserted into the data port of the mobile telephone by the user for executing applications, without modifying any hardware or software of the mobile telephone itself. An exemplary telephonic application is presented, which monitors outgoing calls on the mobile telephone, and automatically reroutes long-distance calls through a calling-card or call-back service to obtain lower-cost calling rates. This application is transparent to the user and allows the user to place calls using the mobile telephone's phone book, speed-dialing, or redial features, and without having to enter local access numbers, calling-card account numbers, or other service access codes. Other applications, including non-telephonic applications, can be pre-programmed or downloaded by the user.

The present application claims benefit of U.S. Provisional Patent Application No. 60/638,150 filed Dec. 21, 2004.

### FIELD OF THE INVENTION

The present invention relates to mobile telephones, and, more particularly, to a plug-in device for enabling mobile telephones to execute applications.

### BACKGROUND OF THE INVENTION

A mobile telephone is generally supplied to the user with one or more embedded applications. Applications may relate to the use of the mobile telephone in telephony, such as telephone number management (“phone book”) or call analysis. Applications may also be unrelated to telephony, such as calculator functions, calendar/scheduling, games, and so forth.

For certain classes of mobile telephones, such as the so-called “Smart Phone” having a standardized operating system, it is possible for the user to download and install additional applications. These downloadable applications function by means of program code which makes low-level subroutine calls to the telephone's operating system, and make it possible for the user to execute specialized applications on the telephone. The fact that these applications can be downloaded means that the telephone does not have to be reprogrammed, or to have the internal software or hardware of the telephone altered.

The capability of adding specialized applications to the telephone is a valuable benefit to the user. New applications are continually being innovated for mobile telephones, and such a capability allows a user to take advantage of the new applications without having to modify the telephone or obtain a new telephone.

Unfortunately, however, not all mobile telephones have standardized operating systems (such as the standardized operating systems of “Smart Phones”), and therefore cannot execute new loadable applications, such as downloadable applications.

There is thus a widely recognized need for, and it would be highly advantageous to have, a means of executing loaded applications, such as downloaded applications. This goal is met by the present invention.

### SUMMARY OF THE INVENTION

The present invention is of a self-contained device (herein denoted as an “application plug”) which plugs into a mobile telephone via an existing interface socket of the telephone, and which allows the telephone to execute custom user applications which are loaded into the plug. The term “loadable” herein denotes an application which can be installed (also denoted herein as “loaded”) into a device without physically altering the internal portion of the device. The term “downloadable” herein denotes an application which can be installed (also denoted herein as “downloaded”) into a device via a network. The term “network” herein denotes any collection of interconnected devices, including, but not limited to data networks and telephone networks, however connected, including, but not limited to: wired connection; wireless connection; virtual circuit; point-to-point connection.

In an embodiment of the present invention, an application plug connects to a mobile telephone through the telephone's external data port. In another embodiment of the present invention, an application plug connects to a mobile telephone through an internal connecting socket. Certain mobile telephones have internal connecting sockets that are easily available by removing a back panel.

Types of Applications which can be Executed by the Application Plug

Examples of applications which can be executed (“run”) by an application plug according to the present application include, but are not limited to:
1. Using the mobile telephone to make calling-card and call-back calls automatically and seamlessly, as described in co-pending PCT application number IL2005/000581 of one of the present inventors, and discussed in detail below.
2. Using the mobile telephone to execute an application that can also execute within the telephone.

### Benefits of the Application Plug

An application plug according to embodiments of the present invention offers many advantages, including, but not limited to:
1. Application plugs according to certain embodiments of the present invention can execute applications requiring more extensive processing and memory capabilities than the telephone itself is capable of executing. As a non-limiting example, a particular mobile telephone might be able to accept only a few hundred names and phone numbers in its “phone book”, whereas an application plug according to embodiments of the present invention can handle a “phone book” containing many thousands of names and phone numbers.
2. Application plugs according to certain embodiments of the present invention are not restricted by limitations of Java implementations, which in many cases cannot access the mobile telephone's radio module, DTMF dialer, and/or network interface. Likewise, application plugs according to the present invention are not restricted by limitations of SIM toolkit applications (for running on GSM mobile telephones). Application plugs according to embodiments of the present invention access the radio module, DTMF dialer, and/or network interface via AT commands, a similar standard, or other command set for control and monitoring interfacing to a mobile telephone, to perform actions including, but not limited to: initiate calls; dial calls; transmit DTMF tones; monitor outgoing calls; and hang up calls.
3. Application plugs according to embodiments of the present invention can execute applications on mobile telephones that do not have standardized operating systems (such as the standardized operating systems of “smart phones”).
4. An application can be pre-installed into an application plug according to embodiments of the present invention prior to acquisition by a user, so that a user acquiring such an application plug can insert the application plug into a mobile telephone and immediately execute the pre-installed application. According to other embodiments of the present invention, applications can be loaded or downloaded by the user into an application plug that is already in the user's possession.
5. According to embodiments of the present invention, a user can insert an application plug into a mobile telephone and execute an application of the application plug without adding or changing the existing software or hardware of the mobile telephone itself.

Therefore, according to the present invention there is provided an application plug device for connecting to a mobile telephone via a data port of the mobile telephone and for executing an application via the mobile telephone, the mobile telephone having a user interface, the application plug device including: (a) memory, for storing data and executable code for the application; (b) a processor, for executing the executable code; and (c) a connector having electrical contacts, for connecting to the data port of the mobile telephone, for obtaining electrical power from the mobile telephone to operate the memory and the processor, and for exchanging data signals with the mobile telephone to access the user interface of the mobile telephone and to enable the execution of the application; wherein: (i) the application plug device connects directly to the mobile telephone without utilizing a cable; (ii) the data and power connection to the application plug device consists solely of the connector for connecting to the data port of the mobile telephone; and (iii) the user interface of the application plug device consists solely of the mobile telephone user interface.

Also, according to the present invention there is provided, for use with an application plug device operative to connect to a mobile telephone via a data port of the mobile telephone, a method for redirecting a long-distance outgoing call placed by the user through an alternative calling service having a local access number, wherein the method comprises: (a) connecting the application plug device to the mobile telephone; (b) monitoring user call placement by the application plug device; (c) determining, by the application plug device, that the user has placed an outgoing call and has entered a destination telephone number on the mobile telephone; (d) obtaining, by the application plug device, the destination telephone number; (e) determining, by the application plug device, whether the destination telephone number corresponds to a long-distance call; and (f) if the destination telephone number corresponds to a long-distance call: (i) hanging up the outgoing call, by the application plug device; (ii) dialing the local access number of the alternative calling service, by the application plug device; and (iii) completing the outgoing call by the application plug device, via the alternative calling service.

In addition, according to the present invention there is provided a method for programming an application into an application plug device operative to connect to a mobile telephone via a data port of the mobile telephone, wherein the mobile telephone has at least one data interface characteristic, the method including: (a) obtaining a data interface specification for the mobile telephone, including the at least one data interface characteristic; (b) determining a set of data interface characteristics for implementing the application; (c) creating executable code for the application plug device operative to execute the set of data interface characteristics; and (d) programming the executable code into the application plug device.

### BRIEF DESCRIPTION OF THE DRAWINGS

The invention is herein described, by way of example only, with reference to the accompanying drawings, wherein:

FIG. 1 is a conceptual diagram showing a mobile telephone with an application plug according to embodiments of the present invention.

FIG. 2 is a flowchart of a non-limiting example of a telephonic application which can be executed by an application plug according to an embodiment of the present invention.

FIG. 3 is a conceptual diagram showing an arrangement for an application plug development system according to an embodiment of the present invention.

FIG. 4 is a flowchart of a method, according to an embodiment of the present invention, of developing an application plug.

### DESCRIPTION OF THE PREFERRED EMBODIMENTS

The principles and operation of an application plug according to the present invention may be understood with reference to the drawings and the accompanying description.

### The Mobile Telephone Data Port

Application plugs according to certain embodiments of the present invention interface to a mobile telephone via the telephone's data port. The term “data port” herein denotes an external signal and power socket of a mobile telephone, which is typically intended to enable connecting the telephone via a cable or adapter to external devices such as battery rechargers, speaker-microphone devices (“hands-free” apparatus), computers, and diagnostic/programming devices; and which is capable of supplying electrical power and data signals to an external device, and receiving data signals therefrom. Application plugs according to the present invention represent a novel use for a mobile telephone data port, for continual monitoring of the activities of the mobile telephone, and using the results thereof for performing additional applications in an automatic and seamless manner. By “seamless”, it is meant that an application executed by the application plug executes and interfaces with the user of the mobile telephone in such a way that to the user it appears as if the telephone itself is executing the application, in a manner consistent with the applications which are embedded directly in the telephone and which are executed thereby.

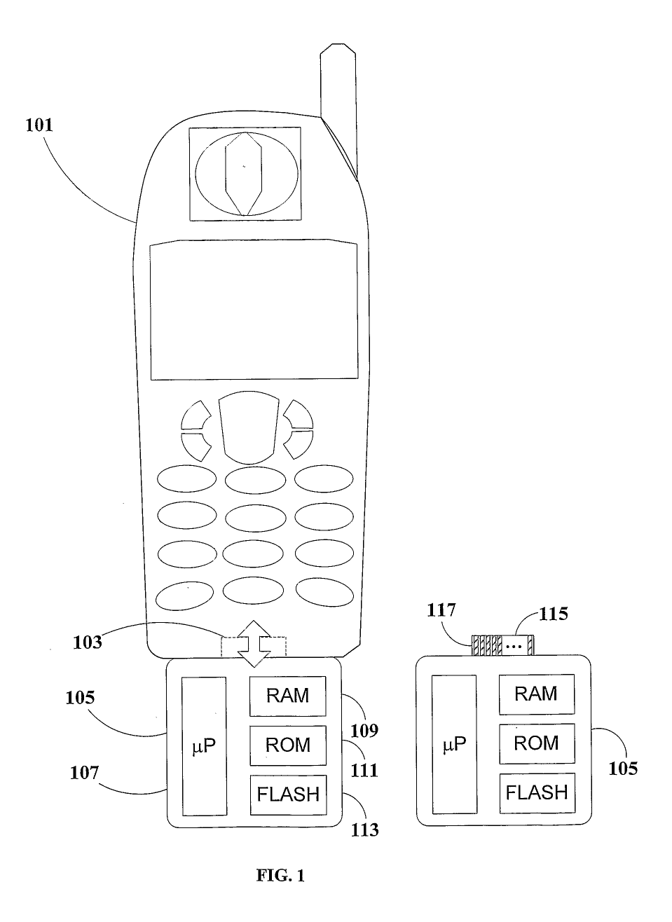

FIG. 1 is a conceptual diagram showing a mobile telephone 101 having a data port 103 into which is plugged an application plug 105 according to embodiments of the present invention. All power and data connections to application plug 105 are via data port 103. Also shown in FIG. 1 is a detail of a connector 115 of application plug 105, having electrical contacts 117 for establishing power and data connections with data port 103. Within application plug 105 is a processor (μP) 107 and memory according to the specific embodiment: read-write Random-Access Memory (RAM) 109; Read-Only Memory (ROM) 111; and flash memory 113 providing non-volatile read-write program and data storage. The terms “Read-Only Memory” and “ROM” herein denote memory including, but not limited to: mask-programmed read-only memory, field-programmable memory (also known as “PROM”), and electrically-erasable field-programmable memory which can be used to store program data (also known as “EEPROM”). In certain non-limiting embodiments of the present invention, one or more of RAM 109, ROM 111, and flash memory 113 are combined together with processor 107 into an integrated controller; the term “processor” herein denotes any such device which includes a data processor and any combination of memory, sometimes denoted as a “microprocessor”, “controller”, or “microcontroller”. In particular, processors suitable for use with mobile telephones manufactured by Nokia Corporation include, but are not limited to the Microchip PIC16F84A; processors suitable for use with mobile telephones manufactured by Motorola Corporation include, but are not limited to the Microchip PIC12F629.

Typically, ROM contains program code for the application(s) of the application plug and for implementing the application plug operation; RAM contains live (temporary) data used by the application(s) of the application code; and flash memory is used for storing executable code for the application(s) and persistent data used by the application(s) of the application plug (including, but not limited to: telephone numbers; call records; access codes; and user data).

It is noted that application plugs according to the present invention have the following characteristics:
Cordless—application plugs according to the present invention plug directly into the mobile telephone data port (such as data port 103) without utilizing any cable. The term “cable” herein denotes an electrical cord capable of carrying electrical power and/or electrical signals.
Self-contained—application plugs according to the present invention derive electrical operating power from the mobile telephone via the mobile telephone data port (such as data port 103) and have no separate battery, electrical power connection, or electrical power source.
No external user interfacing—application plugs according to the present invention have no separate user interface, and utilize only the user interface of the mobile telephone. The term “user interface” herein denotes any keypad, user-operable switches, buttons, audio/visual/tactile indicators, displays, printers, scanners, or other user input/output, or combination thereof. As noted, all application plug functions which require user interfacing (user input/output) employ the user interface of the mobile telephone.
No external data connections—application plugs according to the present invention have no data interfaces other than the connection to the mobile telephone data port (such as data port 103); the mobile telephone data port is the sole data interface for application plugs according to the present invention; application plugs according to the present invention do not utilize any other connections for data input/output. The term “data connection” herein denotes devices including, but not limited to: electrical connectors; radio receivers/transmitters; electromagnetic transducers; antennae; sonic transducers; infrared links; card readers/writers; and GPS receivers.
It is noted that, in the context of downloading, an application plug according to the present invention accesses networks only through a mobile telephone, and therefore downloads only through a mobile telephone.

In a non-limiting embodiment of the present invention, an application plug is a generalized platform for purely telephonic applications. In another embodiment of the present invention, an application plug has an operating system implemented by means of primitive commands of the mobile telephone itself. In a further non-limiting embodiment of the present invention, primitive commands utilized include the AT command set, as referenced in AT command set for GSM Mobile Equipment, the ETSI TS 100 916 standard. In yet an additional embodiment of the present invention primitive commands utilized include the Sony Ericsson GM41 AT Command Manual. This is covered in more detail below.

Unless specifically stated otherwise, the utilization of terms such as “processing”, “computing”, “calculating”, “determining”, or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, “processor”, “computer”, “apparatus”, “system”, “sub-system”, “module”, “unit”, “device” (in single or plural form) for performing the operations herein. This may be specially-constructed for the desired purposes, or may comprise a general purpose computer selectively activated or reconfigured by a computer program stored in the computer. Such a computer program may be stored in a computer readable storage medium, including, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed via a computer system bus.

The processes/devices (or counterpart terms specified above) and displays presented herein are not inherently related to any particular computer or other apparatus, unless specifically stated otherwise. Various general-purpose systems may be used with programs in accordance with the teachings herein, or it may prove convenient to construct a more specialized apparatus to perform the desired method. The desired structure for a variety of these systems will appear from the descriptions herein. In addition, embodiments of the present invention are not described with reference to any particular programming language. It will be appreciated that a variety of programming languages may be used to implement the teachings of the inventions as described herein.

### Example of a Telephonic Application

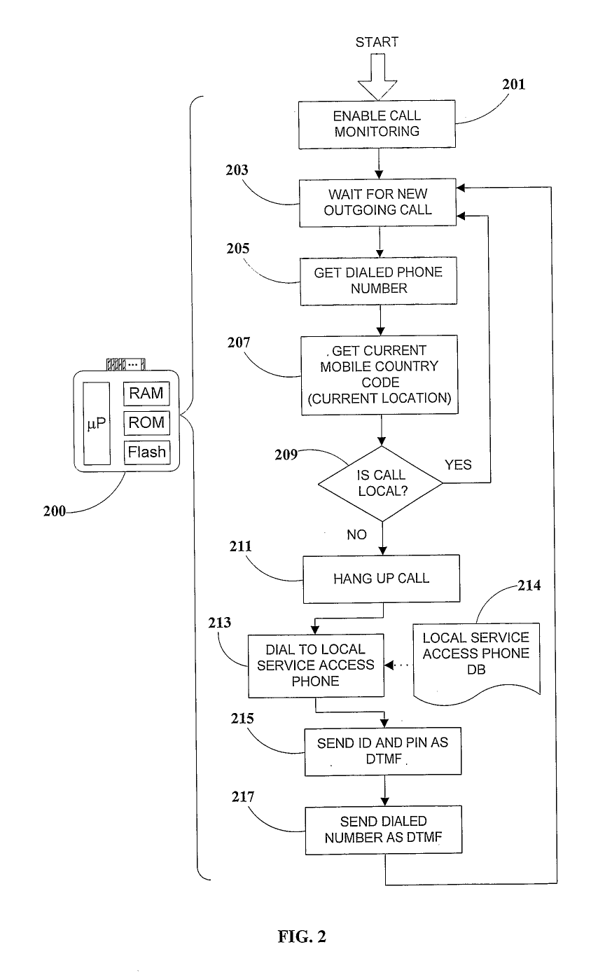

FIG. 2 illustrates a flowchart for a non-limiting example of a telephonic application which can be executed by an application plug according to an embodiment of the present invention.

The telephonic application illustrated in FIG. 2 allows the user to benefit from low-cost long-distance calling programs, such as calling-card programs and call-back programs, without having to manually handle the dialing overhead normally incurred by such programs. Instead, the dialing overhead of using a calling-card program is handled automatically by the application executed by an application plug according to the present invention. This application is also described in detail in co-pending PCT application number IL2005/000581 of one of the present inventors. For example, a calling-card offers the user substantial savings on long-distance calling, but typically requires the user to dial a local access number, wait for a prompt, enter the serial number of the calling card, and then enter the number of the telephone to be called. This is a time-consuming and burdensome operation which is prone to error. Moreover, a user employing a calling card cannot benefit from the conveniences normally associated with mobile telephones. In particular, mobile telephones typically allow various shortcuts in placing calls, including, but not limited to phone-book dialing, speed dialing (also called “one-touch” dialing), redial (of the previously-dialed phone number). All of these shortcuts make it easier and faster to dial long-distance telephone numbers with reduced risk of error. None of them, however, are available for placing calling-card calls. Instead, an application plug according to an embodiment of the present invention can give the user the benefits of the calling card's lower costs, while performing the tedious entry of the local access number, calling card number, and telephone number. The application plug performs these functions by redirecting a long-distance call placed by the user through an alternative calling service, such as a calling-card or call-back service. The application plug performs all supporting operations necessary to utilize the alternative calling service, including, but not limited to: dialing a local access number; entering a user account number; entering a user PIN (Personal Identification Number); entering access codes; receiving a callback; and waiting for signals from the alternative calling service to coordinate input. Furthermore, the application plug can dial the telephone number correctly, no matter how the user entered the telephone number (such as by phone-book dialing, speed dialing, redial, in addition to direct manual entry). Moreover, the application plug performs these operations in a manner that is not perceived by the user as being different from the normal call procedures.

In the description below, it is written that an application plug (a device) performs certain actions and possesses certain properties. This is intended to mean the same as writing that an application (a program) executed by the application plug performs those actions and possesses those properties. To the user, there is no apparent difference between attributing the actions and properties to a device or to a program executed by the device. Moreover, to the user it appears as though the mobile telephone is performing the actions and has the properties.

The application illustrated in FIG. 2 is as follows: In a step 201, the monitoring of calls made with the mobile telephone is enabled by an application plug 200. Thereafter, from this point forward, application plug 200 monitors the dialing and call placement performed by the user (also referred to as the “subscriber” by the mobile telephone Service Provider). A step 203 waits for the user to place a new outgoing call and determines that the user has placed an outgoing call in which the user enters a destination telephone number on the mobile telephone. It is noted that the user may enter the destination telephone number in various different ways, including, but not limited to: direct dialing, speed dialing, phone-book dialing, recent number dialing, and call log dialing. When the user attempts to place an outgoing call, in a step 205 application plug 200 detects the user attempt to place an outgoing call and gets the dialed destination telephone number. In an optional step 207 application plug 200 gets the current location of the mobile telephone in the form of the country code; step 207 is not always necessary—in an embodiment of the present invention, there are cases where the outgoing telephone call is known by application plug 200 to be an international call. The term “destination telephone number” herein denotes any symbol or sequence of symbols which specifies a destination for the outgoing call, including, but not limited to numbers, numeric character strings, alphabetic character strings, alphanumeric character strings, symbol character strings, punctuation character strings, and combinations thereof. The term “country code” herein denotes any codes which designate regions including, but not limited to: geographical regions, political regions, and mobile telephony network regions. The current “location” of a mobile telephone is typically expressed in terms of such regions, but may also be expressed in terms of a geographical coordinate system fixed with respect to the earth's surface, including, but not limited to: global longitude-latitude systems, grid systems, the Universal Transverse Mercator (UTM) system; the World Geodetic System 1984 (WGS 84); and the U.S. National Grid (USNG) system. The verbs “dial”, “dialing”, “dialed”, “enter”, “entering”, “entered” and the like herein denote any action to enter data into a mobile telephone and to indicate choices thereto, including, but not limited to: destination telephone numbers, commands, selections, and responses. Furthermore, such actions associated with the verbs “dial”, “dialing”, “dialed”, “enter”, “entering”, “entered”, and the like herein include, but are not limited to: user key press on a keypad, or user activation of a button, control, or sensor of the mobile telephone; user voice activation; and automatic (programmatic) or machine entry of data into the mobile telephone, such as by an application plug according to the present invention.

At a decision point 209 application plug 200 determines whether or not the call the user is attempting to place is a local call or a long-distance call by examining the destination telephone number. If the call corresponds to a local destination, then there is no need to use alternate routing for the call, and application plug 200 resets by returning to step 203. The call is then completed by the mobile telephone through direct dialing without any involvement of application plug 200.

The term “alternate routing” herein denotes an alternative means of placing the outgoing call, including but not limited to: direct dialing; calling card; and call-back program. Typically, an alternate routing is associated with a service access destination telephone number, and typically the service access destination telephone number is a local telephone number.

If, however, the call is not a local call but rather that the user is attempting to place a long-distance call (the destination telephone number corresponds to a long-distance call), in a step 211 application plug 200 hangs up the call. In effect, the automatic call manager which executes the present method aborts the direct-dialed call which the user has just attempted to place; the aborting occurs before the call is actually placed, so that there is no charge incurred by the user for the attempted direct-dialed call. In the process of the user's attempting to initiate the call, however, the mobile telephone will have captured the number which the user has dialed. This is the case regardless of how the user has placed the direct-dialed call. For example, the user may have dialed the complete number manually by pressing the keypad digits corresponding to the long distance number; the user may have utilized a “speed dialing” preset button; the user may have recalled a recently-dialed number; the user may have selected the number from the mobile telephone's “phone book” or call log; the user may have dialed the number via speech; or the user may have used some other shortcut to dial the number. In this manner, an application plug according to embodiments of the present invention is compatible with all the user conveniences offered by the mobile telephone. The term “long-distance call” herein denotes an outgoing call including, but not limited to: a call to a different network, a call to a region with a different country code, and a call not considered by the network to be a local call.

Continuing with the discussion of FIG. 2, after the user's attempted call placement has been aborted in step 211, in a step 213 application plug 200 determines an alternate routing for the outgoing call, including, but not limited to: calling card, and call-back program. In step 213 application plug 200 also accesses the service which provides that alternate routing for the outgoing call. A database 214 contains local access numbers provided by the calling card/call-back program service provider, and may also specify the dialing format of the local service access call. The geographical extent of the entries of database 214 depends on the geographical extent of the calling card/call-back program service provider's reach; the database can be regional or international in scope. In an embodiment of the present invention, the application plug accesses the service by dialing a service access number; in other embodiments of the present invention, the application plug accesses the service by means including, but not limited to: opening a data session via GPRS, opening a data session via WiFi, and other means of opening a data session which can be performed by the mobile telephone. Application plug 200 knows the dialing pattern and format for the calling card being used in the particular location from which the call is being made. In an embodiment of the present invention, application plug 200 selects the alternate routing from multiple routings and is optimized according to predetermined criteria, such as most economical for the subscriber. The dialing of the local service access number and the entering of all pertinent data is done automatically by application plug 200 without any user intervention. Application plug 200 then completes the placement of the outgoing call via the alternate routing. In an embodiment of the present invention, in a step 215 application plug 200 sends the subscriber ID and PIN (“Personal Identification Number”) as a DTMF (“Dual Tone Multi-Frequency”) sequence (in the local service access format, such as specified in database 214) so that the calling card service or call-back program can properly identify and authorize placement of the call. Finally, in a step 217 application plug 200 sends the long-distance number to be dialed.

A non-limiting example of steps 213, 215, and 217 is as follows for a calling card service, in terms of AT commands:

| | | |
|---|---|---|
| Step 213 | ATD LLL | LLL is the local access number for the |
| | | calling card service provider, obtained from |
| | | database 214 |
| Step 215 | ATD ID | ID is the user account number for the |
| | | calling card |
| | ATD PIN | PIN is the user's Personal Identification |
| | | Number to authorize billing the call to the |
| | | user's account |
| Step 217 | ATD NNN | NNN is the long-distance telephone number |
| | | the user wants to call |

Not only does an application plug according to this embodiment of the present invention save the user money by automatically rerouting long-distance calls through a more economical alternative service, but (as indicated above), the application plug saves the user the trouble of dialing all the numbers listed above. In particular, the user can dial a long-distance call via a single keystroke with a “speed-dialing” entry. In contrast, to use a calling card service manually, “speed dialing” and other shortcuts cannot be used. The user has to manually dial the numbers above, entailing not only additional work, but the risk of misdialing one or more of the numbers.

For a call-back program, an application plug according to another embodiment of the present invention also receives the call-back. Once again, this is done automatically by the application plug without requiring additional input from the subscriber. Other necessary actions, such as pausing between transmitting sequences, waiting for special tones or signals from the local access server, or answering the call-back are also handled automatically by the application plug.

In addition, the present invention contemplates a computer program product for executing the above-described method for automatically rerouting long-distance telephone calls.

### Examples of Using the AT Command Set

As previously noted, a non-limiting embodiment of the present invention utilizes an AT command set, such as is referenced in AT command set for GSM Mobile Equipment, the ETSI TS 100 916 standard; and the Sony Ericsson GM41 AT Command Manual.

As a non-limiting example, a subset of AT commands for mobile telephones manufactured by the Sony Corporation (including, but not limited to the Sony model T630) which implement the exemplary telephonic application detailed previously is given in Table 1 as follows:

TABLE 1
Non-limiting example of AT commands (for a Sony mobile
telephone) which implement an exemplary application
according to an embodiment of the present invention

| Data Interface Characteristic | Function |
|---|---|
| AT*ECAM=1 | causes the phone to start reporting |
| | new calls |
| *ECAV: 1,1,1, , , “NNN”,129 | phone reports a new outgoing voice |
| | call to number “NNN” |
| AT+CHLD=1 | hang up the active call |
| ATD NNN | dial telephone number NNN |
| AT+VTS=“1” | send the DTMF tone “1” through |
| | the call |

It is noted that the AT commands in Table 1 may vary according to the specific manufacture and model of mobile telephone being used. In another non-limiting example for comparison, the command AT+CKPD=E is used to hang up the active call for telephones manufactured by the Motorola Corporation (including, but not limited to the model V300).

### Pseudo-Code Example of a Telephonic Application

Following is another non-limiting example of a telephonic application which can be performed by an application plug according to embodiments of the present invention. In this example, an application plug monitors outgoing calls and records the length of the longest outgoing telephone call. A non-limiting example of pseudo-code describing an algorithm for this operation is as follows:

```
//initialize communication with phone.
//initialize _longest_call_number := “”.
//initialize _longest_call := 0.
//send MEcommand: <start monitoring outgoing calls>.
//begin loop waiting for new message from ME.
  //if received MEmessage: <new outgoing call to “NNN”>, then:
    //store _dialed_number := “NNN”;
    //store _start_time := MEquery: <clock_time?>.
  //if received MEmessage: <outgoing call disconnect>, then:
    //store _end_time := MEquery: <clock_time?>;
    //compute _call_duration := _end_time − _start_time.
      //if _call_duration > _longest_call, then:
        //store _longest_call_number := _dialed_number;
        //store _longest_call := _call_duration.
//end loop waiting for new message from ME.
```

The above pseudo-code can readily be translated into the appropriate operational source code for the application plug, and assembled or compiled into executable code.

In the above pseudo-code example, local variables are denoted by a leading underscore (e.g., _longest_call_number).

In the following description, the “data interface characteristics” of the mobile telephone are considered to include: “commands”, which are instructions to perform a particular operation; “queries”, which are requests for data, each of which is associated with a response containing the requested data (or an error message if no response to the query can be made); and “messages”, which are event notifications from the mobile telephone.

Commands to the mobile telephone (“Mobile Equipment”, or “ME”) are denoted by the pseudo-code MEcommand: <command>. A non-limiting example of a pseudo-code command is MEcommand: <start monitoring outgoing calls>. In Table 1 above, and as described in section 4.13 of the Sony Ericsson GM41 AT Command Manual, it can be seen that for a Sony mobile telephone this pseudo-code command translates into sending the character string “AT*ECAM=1” to the mobile telephone.

Queries for information from the mobile telephone are denoted by MEquery: <query?>. A non-limiting example of a pseudo-code query is MEquery: <clock_time?>, to get the current local time from the mobile telephone. From Section 8.15 of AT command set for GSM Mobile Equipment, the ETSI TS 100 916 standard, it can be seen that a non-limiting example of the translation of such a pseudo-code query involves the sending of the character string “AT+CCLK?” to a mobile telephone, which answers a character string containing the current local time. The conversion of this character string into a time data-type for computing elapsed time is implied in the above pseudo-code example, as is well-known to those familiar with the art. The term “query” herein also denotes mobile telephone commands referred to as “read” commands and “functions”.

Event-notification messages from the mobile telephone are denoted by MEmessage: <message>. A non-limiting example of a pseudo-code event message is MEmessage: <new outgoing call to “NNN”>, which indicates that the user has dialed an outgoing call to a telephone number represented by the character string “NNN”. In Table 1 above, and as described in Section 4.13.1 of the Sony Ericsson GM41 AT Command Manual, it can be seen that for a Sony mobile telephone this pseudo-code message translates into the character string “*ECAV: 1,1,1, . . . , “NNN”, 129” from the mobile telephone. The parsing of this character string to retrieve the telephone number substring “NNN” is implied in the above pseudo-code example, as is well-known to those familiar with the art.

### Adapting an Application Plug to a Mobile Telephone

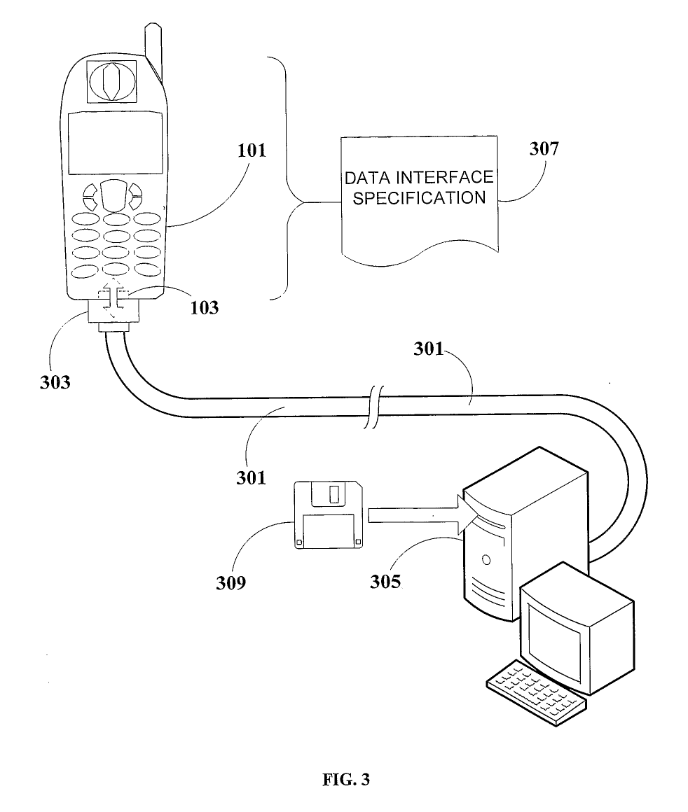

FIG. 3 conceptually illustrates an arrangement for an application plug development system for mobile telephone 101 according to an embodiment of the present invention. A cable 301 connects mobile telephone 101 to workstation 305 from mobile telephone data port 103 via a plug 303. Cable 301 is typically available from the manufacturer of mobile telephone 101. Along with cable 301, the mobile telephone manufacturer typically also supplies software 309 which communicates and exchanges data with mobile telephone 101. Through the use of software 309, it is possible to send commands to mobile telephone 101, and to send queries thereto and receive responses and messages therefrom, similar to the commands, queries, and messages of the pseudo-code example presented above. Also, data interface specifications 307 contain information about the physical, electrical, and data characteristics of data port 103, and the data interface characteristics of the mobile telephone, including the commands, queries, and messages to which mobile telephone 103 responds. Data interface specification 307 includes, but is not limited to, documents such as: AT command set for GSM Mobile Equipment, the ETSI TS 100 916 standard; and the Sony Ericsson GM41 AT Command Manual. Specification 307 also includes, but is not limited to, information obtained from analyzing the signals on cable 301 corresponding to commands entered on workstation 305, as translated by software 309. By intercepting the data stream at data port 103, it is possible to determine a set of commands, queries, and messages, even without formal documentation. In addition, many documented and undocumented commands for mobile telephones are known in the art, some of which are furthermore published via Internet user forums. Data interface specification 307 also includes, but is not limited to, such information. The term “data interface specification” herein thus denotes any information or collection of information from which the commands, queries, and/or messages of a mobile telephone may be obtained, for access through the data port of the mobile telephone.

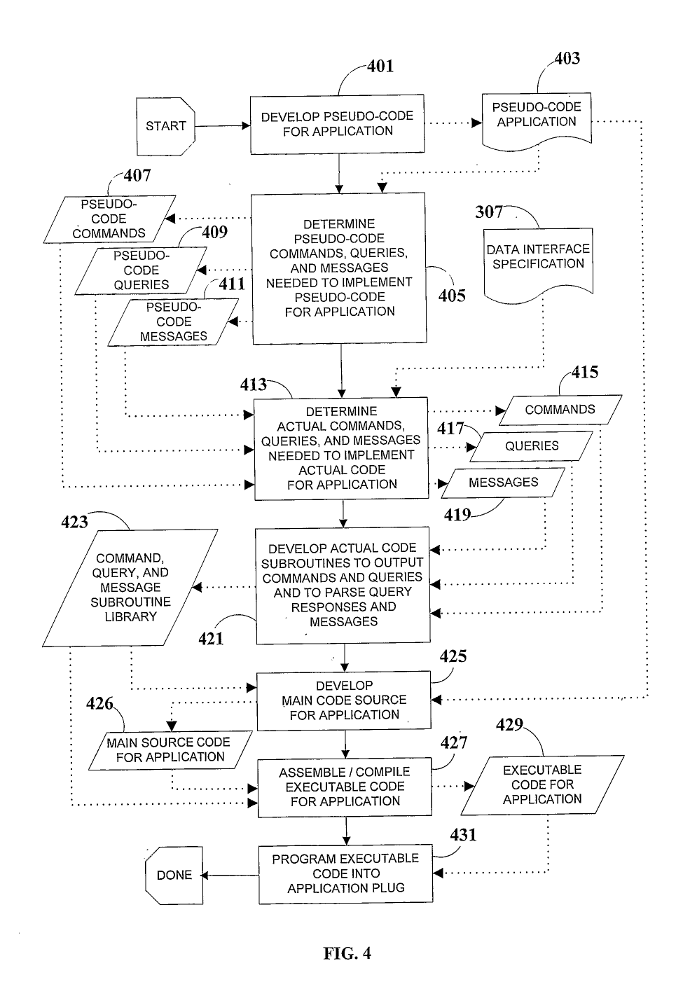

FIG. 4 is a flowchart of a method, according to an embodiment of the present invention, of developing an application plug as described herein.

At the start of the method, in a step 401, an algorithm for the desired application is developed in a pseudo-code expression 403, or via a similar high-level description. In a step 405 are determined at the pseudo-code or similar high level description, the commands 407, queries 409, and messages 411 needed to be sent to the mobile telephone and/or received therefrom in order to implement the application as described in pseudo-code expression 403. Next, the actual commands 415, queries 417, and messages 419 for interfacing with the mobile telephone are determined from their respective pseudo-code counterparts, by consulting data interface specification 307, as previously described above. With actual commands 415, queries 417, and messages 419, in a step 421 a command, query, and message subroutine library 423 is developed. The code in this library handles the output of commands and queries to the mobile telephone, and the input, parsing, and processing of query responses and messages from the mobile telephone. The term “subroutine” herein denotes any short piece of code which can be called or embedded inline in other code. With library 423 available, main source code 426 for the application described in pseudo-code 403 is developed in a step 425. Library 423 can be pre-existing and can also be reused for the development of other applications for the same class of mobile telephone. Then, in a step 427, main source code 426 is assembled or compiled along with the appropriate routines from library 423 into executable code 429. The terms “assemble” and “compile” herein refer generally to any process or set of processes for deriving executable code from higher-level code, and encompass any required auxiliary processes, including, but not limited to, processes of linking and binding. Finally, in a step 431, executable code 429 is programmed into the application plug. The term “program” in the context of embedding code into a device, herein denotes any process for providing machine-readable and machine-executable code to the device, including, but not limited to: mask-programming; PROM-burning; loading or downloading into machine-readable memory of any kind; storage in EEPROM; and storage in flash memory.

It is also understood that the mechanical and electrical characteristics of connector 115 (FIG. 1) which plugs into data port 103 can be determined by examination and measurement of plug 303 (FIG. 3) and the electrical connections thereto, and by electrical probing of data port 103 itself to determine the signal and power assignments for electrical contacts 117 (FIG. 1). It is therefore possible to equip the application plug with connector 115, even if data port 103 has a proprietary geometry and electrical layout for contacts 117.

In addition, the present invention contemplates a computer program product for executing the above-described method for developing an application plug.

While the invention has been described with respect to a limited number of embodiments, it will be appreciated that many variations, modifications and other applications of the invention may be made.

1. An application plug device for connecting to a mobile telephone by being plugged into a data port of the mobile telephone and for executing an application via the mobile telephone, the mobile telephone having a user interface, the application plug device comprising:
memory, for storing data and executable code for the application;
a processor, for executing said executable code; and
a connector having electrical contacts, for connecting to the data port of the mobile telephone by being plugged thereinto, for obtaining electrical power from the mobile telephone to operate said memory and said processor, and for exchanging data signals with the mobile telephone to access the user interface of the mobile telephone and to enable the execution of the application;
wherein:
the application plug device connects directly to the mobile telephone by being plugged into the data terminal without utilizing a cable;
the data and electrical power connection to the application plug device consists solely of said connector for connecting to the data port of the mobile telephone; and
the user interface of the application plug device consists solely of the mobile telephone user interface.

2. The application plug device of claim 1 operative to download an application over a network via the mobile telephone.

3. The application plug device of claim 1, wherein the application plug device is operative to interfacing with the mobile telephone via commands selected from an AT command set.

4. For use with an application plug device operative to connect to a mobile telephone by being plugged into a data port of the mobile telephone, a method for redirecting a long-distance outgoing call placed by the user through an alternative calling service having a local access number, wherein the method comprises:
connecting the application plug device to the mobile telephone, by plugging the application plug device into the data port of the mobile telephone;
monitoring user call placement by the application plug device;
determining, by the application plug device, that the user has placed an outgoing call and has entered a destination telephone number on the mobile telephone;
obtaining, by the application plug device, said destination telephone number;
determining, by the application plug device, whether said destination telephone number corresponds to a long-distance call; and
if said destination telephone number corresponds to a long-distance call:
hanging up said outgoing call, by the application plug device;
dialing the local access number of the alternative calling service, by the application plug device; and
completing said outgoing call by the application plug device, via the alternative calling service.

5. A computer program product storing a computer program for carrying out the method of claim 4.

6. The method of claim 4, wherein:
the application plug device connects directly to the mobile telephone by being plugged into a data terminal thereof without utilizing a cable;
the data and electrical power connection to the application plug device consists solely of said connector for connecting to the data port of the mobile telephone, by being plugged thereinto; and
the user interface of the application plug device consists solely of the mobile telephone user interface.

7. A computer program product storing a computer program for carrying out the method of claim 6.

8. The method of claim 4, wherein the alternative calling service is selected from the group consisting of: calling-card calling service; call-back calling service.

9. A method for programming an application into an application plug device operative to connect to a mobile telephone by being plugged into a data port of the mobile telephone, wherein the mobile telephone has at least one data interface characteristic, the method comprising:
obtaining a data interface specification for the mobile telephone, including the at least one data interface characteristic, wherein said data interface specification applies to data characteristics of the data port into which the application plug device is plugged;
determining a set of data interface characteristics for implementing the application;
creating executable code for the application plug device operative to execute said set of data interface characteristics; and
programming said executable code into the application plug device.

10. A computer program product storing a computer program for carrying out the method of claim 9.

11. The method of claim 9, wherein:
the application plug device connects directly to the mobile telephone without utilizing a cable;
the data and electrical power connection to the application plug device consists solely of said connector for connecting to the data port of the mobile telephone; and
the user interface of the application plug device consists solely of the mobile telephone user interface.

12. A computer program product storing a computer program for carrying out the method of claim 11.

13. The method of claim 9, wherein the at least one data interface characteristic is selected from the group consisting of: commands, queries, and messages.

14. The method of claim 9, wherein the at least one data interface characteristic is selected from an AT command set.
